(19) United States
(12) Patent Application Publication
(10) Pub. No.: US 2025/0182354 A1
(43) Pub. Date: Jun. 5, 2025

(54) PARAMETRIC DEFINITION GENERATION OF MULTI-DIMENSIONAL STRUCTURES FROM DIGITAL IMAGES

(71) Applicant: Oracle International Corporation, Redwood Shores, CA (US)

(72) Inventors: Sahil Malhotra, Hampton (GB); Sergio Aldea Lopez, Valladolid (ES); Matthew Charles Rowe, Milton Keynes (GB); Oleg Gennadievich Shevelev, Chislehurst (GB); Alberto Polleri, London (GB)

(21) Appl. No.: 18/525,343

(22) Filed: Nov. 30, 2023

(51) Int. Cl. G06T 11/60; G06T 7/70; G06V 10/25; G06V 10/74

(52) U.S. Cl. CPC G06T 11/60; G06T 7/70; G06V 10/25; G06V 10/761; G06T 2207/20081; G06T 2207/20084

(57) ABSTRACT

Techniques for generating parametric definitions of multi-dimensional structures from digital images are provided. In one technique, for each image in a set of images, a set of parameter values is stored for a set of parameters of a first function that describes an object in the image. A neural network is trained based on the set of images and the set of parameter values of each image. After training the neural network, an image is input into the neural network. Based on inputting the image into the neural network, an output is generated that comprises a set of output parameter values of a particular object depicted in the image.

### TECHNICAL FIELD

The present disclosure relates to digital image processing and, more particularly, generating parametric definitions of multi-dimensional structures detected in digital images.

### BACKGROUND

Determining a location of an object that is moving along a trajectory is an important problem to solve in multiple contexts, such as tracking racecars or autonomous flying vehicles. One piece of information that is used to determine location is an image that is generated by a camera that is mounted on the moving object. If a track boundary could be detected in the image and the track boundary could be mapped to a ground truth boundary for which location information is available, then the location of the object could be determined with a high degree of accuracy. However, because a moving object (such as a car) may be oriented in a variety of orientations with respect to a track or road, the views of the track boundary itself may be partial or occluded.

Some solutions to address this problem rely heavily on feature engineering and image processing techniques to detect a track boundary and then apply pre-determined perspective transformations to obtain the correct geometric representation of the track boundary in 3D Cartesian space. Parametric representations convert complex 3D geometry information into a set of parameters. For example, a line can be represented by its slope and intercept (two parameters) and a cube can be represented by the 3D location of one of its corners and the size of its edges (four parameters).

Alternative approaches use semantic segmentation techniques to solve the problem, but such techniques require track boundaries to be observed contiguously.

Various applications require a solution to determine the exact position or configuration of a known multi-dimensional (e.g., 2D/3D) structure from a partial visual observation. Some examples include autonomous driving, augmented reality, visual mapping and localization. Existing approaches use image processing and feature based detection or semantic segmentation techniques to extract this information from an input image. These techniques are not robust due to at least two problems. First, perspective transformation from the camera view space to the 3D Cartesian space may be unavailable or erroneous. This will cause errors in the output. Moreover, the further the 2D/3D structure is from the camera, the more difficult is to obtain its accurate representation. Second, object observation in the camera view may be incomplete or occluded by other objects in the image, which can cause the object extraction part of the pipeline to fail.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for estimating a position or location of a moving object, in an embodiment;

FIG. 2 is a diagram that depicts two sets of two edges (or boundaries) of a track: two predicted edges and two actual or real edges, in an embodiment;

FIG. 3 is a flow diagram that depicts an example process for generating a parametric definition of a multi-dimensional structure from a digital image, in an embodiment;

FIG. 4 is a block diagram that illustrates a computer system upon which an embodiment of the invention may be implemented;

FIG. 5 is a block diagram of a basic software system 500 that may be employed for controlling the operation of computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for generating parametric definitions of multi-dimensional structures in a digital image are provided. Embodiments use an approach to learn parametric representations of multi-dimensional structures from partial views of such structures obtained using a single image from a static or moving monocular camera. In one technique, a machine-learned model (e.g., a neural network) is trained using images captured from an object-mounted camera as input and the parametric representation of the road boundary points in the 3D space as labels. The actual track boundary points are used to create a parametric representation of the track boundary as observed from the moving object in the Cartesian space. This is achieved by using regression techniques including, but not limited to, curve fitting, or parametric regression on the (x, y, z) coordinates of the points lying on the track boundary. During application, only the view from the monocular camera provided as input, and the trained machine-learned model, provides the track boundary information in parametric form as output.

Embodiments improve computer-related technology that is related to identifying multi-dimensional structures in a digital image. Embodiments remove the need for feature engineering and the prior knowledge of camera perspective transformation by using a machine-learned model to learn the relationship between the complete image and the geometric representation of a track boundary in 3D Cartesian space directly. With the resulting predicted track boundaries, it is possible to accurately predict the lateral position of a moving object, even at high speed. Embodiments are also more robust to partial and occluded observations of the track boundary.

### System Overview

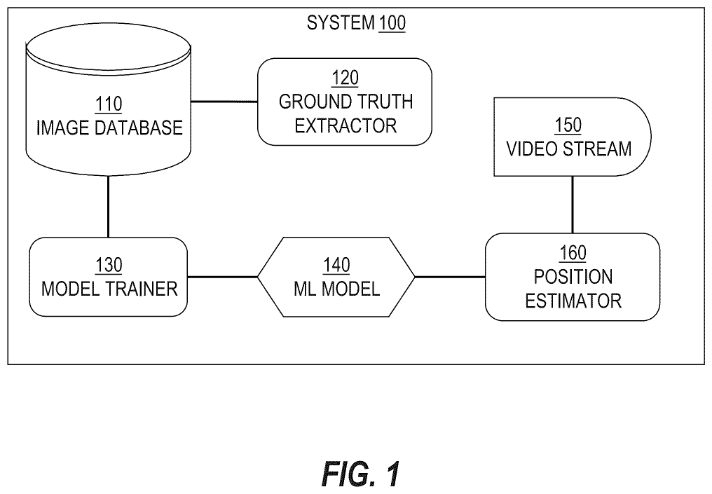

FIG. 1 is a block diagram that depicts an example system 100 for estimating a position or location of a moving object, in an embodiment. System 100 comprises an image database 110, a ground truth extractor 120, a model trainer 130, a ML model 140, a video stream 150, and a position estimator 160. Each of ground truth extractor 120, model trainer 130, and position estimator 160 may be implemented in software, hardware, or any combination of software and hardware.

Examples of objects whose location is being estimated include cars, airplanes, drones, and robots. Any object that can move, and may be locally or remotely controlled or autonomous, may be tracked using embodiments described herein.

Image database 110 comprises images or frames from one or more video footages generated by one or more cameras as the objects, upon which the cameras are mounted, traverse a particular track. The video footages may be limited to video recorded during one or more traversals of the particular track. The more video footages from different positions and angles of the particular track there are to train upon, the more accurate the estimated location will be.

A track may be a racetrack, a road, a highway, a street, a walkway, a path (such as a dirt path outdoors, a bike path, or a path in a manufacturing facility), or an aerial track. Different tracks may have types of boundaries. For example, a racetrack may comprise pavement while the edges of the racetrack border grass or dirt. As another example, cones or other artificial landmarks may designate a boundary of a track.

Image database 110 may comprise different sets of images, each set of images corresponding to a different track.

### Ground Truth Extractor

Ground truth extractor 120 extracts parametric (e.g., polynomial) representations of one or more track boundaries at each of multiple frames or images of one or more video footages. Parametric representations other than polynomial representations may be used to represent a track boundary curve. In one embodiment, such extraction is based on recorded video footages, track maps (a description of track boundaries), where objects travel, and positions of the moving objects with regards to the track. In each image or frame, the moving object may be assigned position (0, 0, 0) in the (x, y, z) Cartesian coordinate system. For some tracks (such as roads), the description of the track boundaries may be obtained from satellite images, road map providers, and/or the use of laser technologies, such as LIDAR.

To simplify the description of the extraction method, the extraction of track boundaries in a 2D coordinate system is described, but it is equally applicable in a 3D coordinate system. Provided that the coordinates of the track boundaries, global or relative to a specific location, and the position of the moving object in the same coordinate system for each frame of the video footage is available, embodiments are able to obtain the parametric representation of one or more track boundaries. In other words, per frame, with a moving object located at the (0, 0) position, each track boundary is extracted as two polynomials, where the relationship between the x and y coordinates is broken to allow for a better fitting of the ground truth track boundary. In an embodiment, extraction comprises the following four main steps.

First, a bounding box in the 2D Cartesian space is generated. An example bounding box is 40 m×40 m, where the moving object (whose location on a track is being determined) is located at the position (0, 0), and the bounding box goes from −20 m to 20 m in the horizontal dimension, and from 0 m to 40 m in the vertical dimension. Once a bounding box is defined, this step does not need to be repeated for any more images in the corresponding video footage, or even any video footage related to the track in question.

Second, the bounding box is projected onto the object position on a recorded trajectory, in such a way that the moving object is placed at the (0, 0) position of the bounding box, and the box is rotated to be aligned with the direction that the camera mounted on the vehicle is facing at that given frame.

Third, one or more track boundaries that fall within the bounding box are extracted. At this step, an extracted track boundary is represented as a set of continuous points in a line, which track boundary may originate from a track map.

Fourth, a parametric fitting is applied to each extracted track boundary, obtaining two polynomials to describe each track boundary. For example, if a cubic parametric fitting is applied and there are two track boundaries, then sixteen parameters are obtained to represent the two track boundaries as follows:

The x and y coordinates of the left boundary are represented by four parameters each:

$${x}_{L} = {a}_{L , x} {u}_{L}^{3} + {b}_{L , x} {u}_{L}^{2} + {c}_{L , x} {u}_{L} + {d}_{L , x}$$

$${y}_{L} = {a}_{L , y} {u}_{L}^{3} + {b}_{L , y} {u}_{L}^{2} + {c}_{L , y} {u}_{L} + {d}_{L , y}$$

The variable u_{L} represents a range of equally spaced numbers that are generated to perform regression on the track boundaries to determine the a_{L}, b_{L}, c_{L} and d_{L} coefficients of the left boundary. The spacing of the numbers u_{L} is chosen so that the corresponding x and y values cover the entire range of the x and y dimensions of the observed track boundaries. The x and y coordinates of the right boundary are represented by four parameters each:

$${x}_{R} = {a}_{R , x} {u}_{R}^{3} + {b}_{R , x} {u}_{R}^{2} + {c}_{R , x} {u}_{R} + {d}_{R , x}$$

$${y}_{R} = {a}_{R , y} {u}_{R}^{3} + {b}_{R , y} {u}_{R}^{2} + {c}_{R , y} {u}_{R} + {d}_{R , y}$$

This approach is also applicable in the 3D Cartesian space. If a track is in the 3D space, then there may be twenty-four total parameters: twelve parameters per track boundary; or sixteen from above plus four for z_{L} and four for z_{R}.

Different tracks may require more or less parameters. For example, a track that includes a tight S-shaped curve or that loops back on itself would benefit from four parameters, whereas a track that that does not include such features may only need three parameters, such as a quadratic equation. For tracks that have only straight lines, such as a square or hexagon-shaped track, then only two parameters (e.g., slope and intercept) may be sufficient to adequately describe the track boundary.

### Model Training

During the training stage, the following information is available: the track boundaries as a set of 2D or 3D points in the Cartesian space, which comes from a track map that is a fixed reference Cartesian space, and the position (in the same fixed reference frame) of the camera from which the input image has been captured. For training, model trainer 130 creates an “input-label” pair where the input is the captured image and, for the label, the relevant points from the track boundaries are extracted and parametric regression is applied to them. In the example above involving two 2D track boundaries, a label consisting of sixteen parameters would exist for each captured image. In the example of a single 3D track boundary, a label may consist of twelve parameters: four parameters for each dimension.

In an embodiment, model trainer 130 trains a neural network comprising a set of encoding layers, which extract the image embeddings, followed by a coefficient prediction branch composed of a set of convolution layers, and a set of fully connected layers, where the shape of the final output corresponds to the coefficients required to describe the track boundaries. Thus, if a label comprises sixteen parameter values, then the final output would be sixteen values, each corresponding to a different one of the sixteen parameters. If a label comprises twelve parameter values, then the final output would be twelve values, each corresponding to a different one of the twelve parameters.

In an embodiment, the images that model trainer 130 uses for training are from different cameras (e.g., with different settings) and/or different object positions on a track. This helps the resulting machine-learned model to be generalized so that, during the inference stage, the machine-learned model may produce accurate output despite the input images coming from cameras that have different settings.

In a related embodiment, images that model trainer 130 uses for training are augmented or modified to simulate different weather and/or lighting conditions. For example, some of the images may be darkened to simulate object movement at night. As another example, some of the images may have rain drops added to simulate object movement during a rain storm. Such augmentation improves the resulting model in making accurate object location predictions in different weather conditions.

### Loss Function

Machine-learned (ML) model 140 (e.g., a neural network (NN)) predicts a set of parameters as output, such as sixteen parameters in the example above. Model trainer 130 trains ML model 140 to minimize a cost function, which may be a difference between predicted parameters values and label parameter values. Thus, the loss function would minimize the magnitude the cumulative difference between the predicted and label parameter values.

However, different parameters have a different impact on the final estimated location or position of the moving object. For example, the parameter value (e.g., a_{L,x}) of the first term in the cubic formula (u_{L}³) may have a higher impact than other parameter values in the formula.

In an alternative embodiment, the cost function is based on the distance between predicted track boundaries and ground truth track boundaries extracted in the ground truth extraction stage. In the loss function, a fixed number of points (e.g., twenty) using the predicted parameters and the label parameters are generated. For example, the predicted parameters for the left track boundary, along with twenty values of u_{L}, are used to generate a set of x-values and a set of y-values based on the following formulas:

$${x}_{L} = {a}_{L , x} {u}_{L}^{3} + {b}_{L , x} {u}_{L}^{2} + {c}_{L , x} {u}_{L} + {d}_{L , x}$$

$${y}_{L} = {a}_{L , y} {u}_{L}^{3} + {b}_{L , y} {u}_{L}^{2} + {c}_{L , y} {u}_{L} + {d}_{L , y}$$

Then, the cumulative sum of Cartesian distance squares between the label points and the prediction points is calculated. Model trainer 130 uses this cumulative sum as the loss, which is input in the back propagation stage of the NN training process. Once the loss drops below a target threshold and does not improve for one or more iterations over the entire training dataset (each iteration referred to as an “epoch”), the training process is deemed complete and is stopped. The weights, coefficients, and/or parameters of ML model 140 are saved (e.g., into a file) to be used during the inference stage.

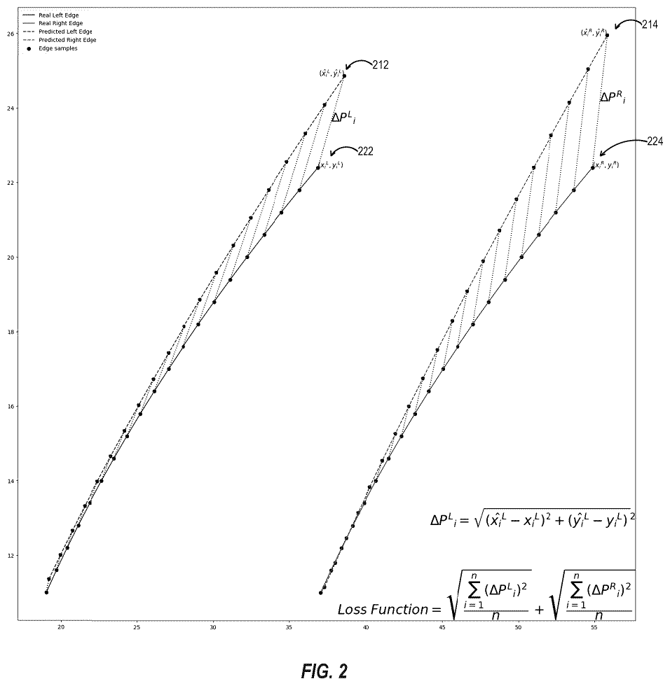

An example formula for the loss function is:

$$\sqrt{\frac{{\sum }_{i = 1}^{n} {( Δ {P}_{i}^{L} )}^{2}}{n}} + \sqrt{\frac{{\sum }_{i = 1}^{n} {( Δ {P}_{i}^{R} )}^{2}}{n}}$$

where ΔPᵢ^{L}=\sqrt{(\hat{x}ᵢ^{L}−xᵢ^{L})²+(ŷᵢ^{L}−yᵢ^{L})²}
FIG. 2 is a diagram that depicts two sets of two edges (or boundaries) of a track: two predicted edges and two actual or real edges. The two predicted edges are predicted left edge 212 and predicted right edge 222. The two real edges are real left edge 214 and real right edge 224. Each edge comprises numerous points. ΔPᵢ^{L} is based on differences between points in predicted left edge 212 and points in real left edge 214. Similarly, ΔPᵢ^{R} is based on differences between points in predicted right edge 214 and points in real right edge 224.

### Inference Stage

During the inference (or application) stage, ML model 140 is loaded from a saved file and one or more images (of an object moving along the same (or similar) track, recorded with a (e.g., monocular) camera) is input to ML model 140. The one or more images may be video stream 150, which comprises many digital images. The video stream may be from a camera that has similar characteristics as the camera (or cameras) that generated the video or frames upon which ML model 140 was trained. Example characteristics that should be similar include facing the same direction (e.g., a front facing camera), field of view, and resolution.

ML model 140, based on each of the one or more images, predicts the parametric coefficients representing one or more track boundaries present in that image. This prediction can be used in a variety of applications including, but not limited to, object localization, path planning, lane detection, etc.

### Lateral Position Estimation

One application of predicted track boundaries is the lateral localization of a moving object in the context of a track that the moving object is traversing. (Longitudinal position can only be determined when the observed track boundaries represent unique sections of the track.) Provided that each track boundary described mathematically as a set of parameters organized in polynomial or parametric form is available, where the moving object is at the position (0, 0) in a (x, y) Cartesian coordinate system, then it is possible to calculate the lateral position of the object. One technique for estimating the lateral position of a moving object based on estimated track boundaries is as follows.

First, the parametric forms of each track boundary are evaluated at y=0, with the assumption that the moving object is at (0, 0) in the input frame or image, and that the estimated track boundaries that serve as input for this method are provided following the same assumption. For example, if only one track boundary is computed, then this step comprises evaluating the parametric equation at y=0, which means the value of u_{L} is found for which y=0. Then, the same value of u_{L} is input to the equation for x in order to find the x value, which is the x position.

Second, the distance between the position of the moving object and the resulting point of each track boundary extracted in the previous step is computed. For example, if the position of the left boundary at y=0 is (14, 0) (where the values are in meters) and the position of the moving object in the input frame/image is (0, 0), then the distance is 14 meters.

If the width of the track is uniform throughout the track, then a distance to a single track boundary is all that is required to determine a lateral position of the moving object. The lateral position of an object may indicate a distance from a reference line, which may be defined as the center point along the entirety of a track. Alternatively, a reference line may be a certain (e.g., consistent or uniform) distance from one of the track boundaries). Alternatively, a reference line may be defined as one of the track boundaries. In this way, if a moving object is moving along the track properly, it will always have a positive lateral position, unless it crosses that track boundary.

If the width of the track is not uniform through the track and the reference line is not defined by a single track boundary (e.g., the reference line is defined as the middle of the track), then two track boundaries may be required in order to determine the lateral position of the moving object.

Each distance measurement may be very accurate, but the uncertainty of the lateral distance can be based on the uncertainty of the track boundary prediction method at the evaluation point y=0. For example, if the system is uncertain of the predicted track boundaries by one meter, then the lateral position predicted therefrom will also be uncertain by one meter. Typically, this uncertainty can be calculated as a function of the distance of the moving object to the track boundaries. The further the track boundary is from the camera, the less precise the prediction may be. Thus, if a distance measurement of a moving object to the left boundary is 1/10 of the distance measurement of the moving object to the right boundary, then, when determining the lateral position of the moving object, the weight given to the left boundary may be ten times greater than the weight given to the right boundary.

Prediction of track boundaries in parametric form allows for the estimating the shape of the track boundaries at longer distances that are visible in an image, or even behind the moving object, with increasing uncertainty as the distance from the moving object increases.

If the track boundary prediction is accurate enough, embodiments described herein can estimate the lateral position of the moving object as accurately as a few centimeters. However, to the extent that other techniques (that do not involve ML model 140 outputting parameter values) are used to determine the lateral position, the output of those techniques may be combined with the output from embodiments described herein to generate a final lateral position estimate. For example, an average of multiple lateral position estimates may be computed. As another example, an uncertainty value of each output is determined and used to determine a weight of each output, which weights are applied to the respective outputs to generate the final lateral position estimate.

### Example Process

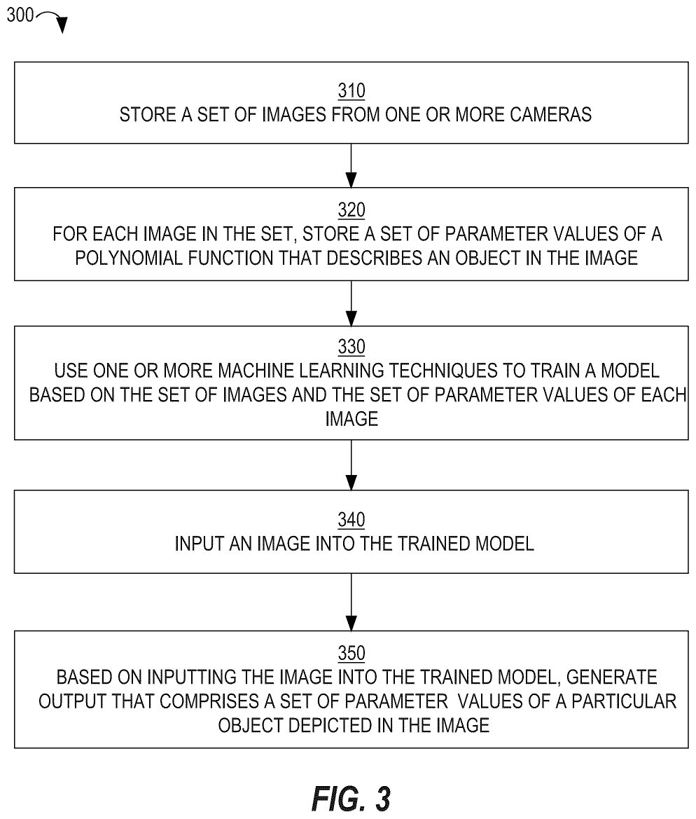

FIG. 3 is a flow diagram that depicts an example process 300 for generating a parametric definition of a multi-dimensional structure from a digital image, in an embodiment. Process 300 may be performed by different components of system 100, such as ground truth extractor 120, model trainer 130, and position estimator 160.

At block 310, a set of images are stored. The set of images may originate from a single digital camera pertaining to a single video file or pertaining to multiple video files, or from multiple digital cameras pertaining to multiple video files. For example, the set of images may be generated by one or more digital cameras that are mounted to one or more vehicles traveling on a track.

At block 320, for each image in the set of images, a set of parameter values is stored for a set of parameters of a polynomial function that describes an object in said each image. The object may be a track boundary or another type of object. The set of parameter values may be determined based on user input or generated automatically by ground truth extractor 120.

At block 330, one or more machine learning techniques are used to train a model based on the set of images and the set of parameter values of each image. The set of parameter values act as labels in the training. The model may be a neural network that comprises multiple layers, such as an embedding layer that generates an embedding based on an image, a convolution layer that receives an image embedding as input, and a fully connected layer that outputs a set of parameter values. Block 330 may be performed by model trainer 130.

At block 340, after the machine-learned model is trained, an image is input into ML model. Block 340 may involve receiving an image from a digital camera, which may be mounted to a moving object. The image may be received in real-time. Position estimator 160 may be part of a computer system that is also mounted to the moving object or that is remote relative to the moving object.

At block 350, based on inputting the image into the ML model, output is generated that comprises a set of output parameter values of a particular object depicted in the image. Blocks 340-350 may be performed by position estimator 160. In the context of track boundaries as objects, the ML model may be trained to output multiple sets of output parameter values, each set for a different track boundary.

Position estimator 160 may then use the output to generate an estimated lateral position of the moving object.

### Advantages

Embodiments are more robust than other techniques for the same problem, due to multiple advantages. For example, the entire image may be used to learn the correlation with a track boundary, or 2D/3D structure, instead of just using foreground/track region information. There are times when a track boundary is predicted accurately even though very little part of the track is visible in the image. Because track boundaries are predicted in their parametric form, it is possible to estimate the shape of the track boundaries that is outside of the original extraction box used during the extraction phase.

As another example, the perspective transformation between the camera image space and the 3D Cartesian space of the world is not required to be known. This calibration is embedded into the neural network itself since labels calculated in the Cartesian space are trained upon directly. This embedded calibration allows embodiments to correctly predict track boundaries without any explicit information of the camera's intrinsic parameters.

As another example, it is possible to generate a significant amount of training data programmatically if the information about the camera position and the geometric information about the target object (e.g., one or more road boundaries) are known a priori.

As another example, embodiments allow for near real-time (milliseconds) prediction of track boundaries surrounding a moving object.

As another example, with predicted track boundaries, it is possible to estimate the lateral distance of the vehicle to each track boundary, even if one of the track boundaries is not visible, and hence accurately locate laterally the moving object on the track. This is not possible with other methods using solely a monocular camera, unless supplementing with other cameras on the side, or a LIDAR sensor, for example.

As another example, an implementation of embodiments is able to estimate the lateral position of a vehicle with a precision of a few centimeters, depending on the vehicle speed, and up to twenty centimeters at velocities higher than 300 km/h.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

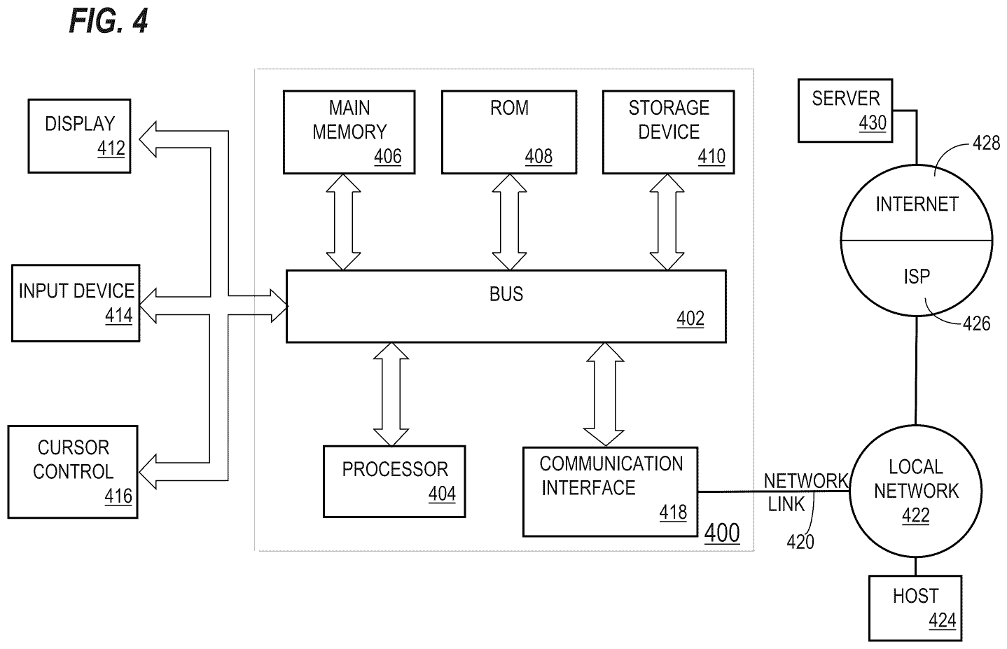

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

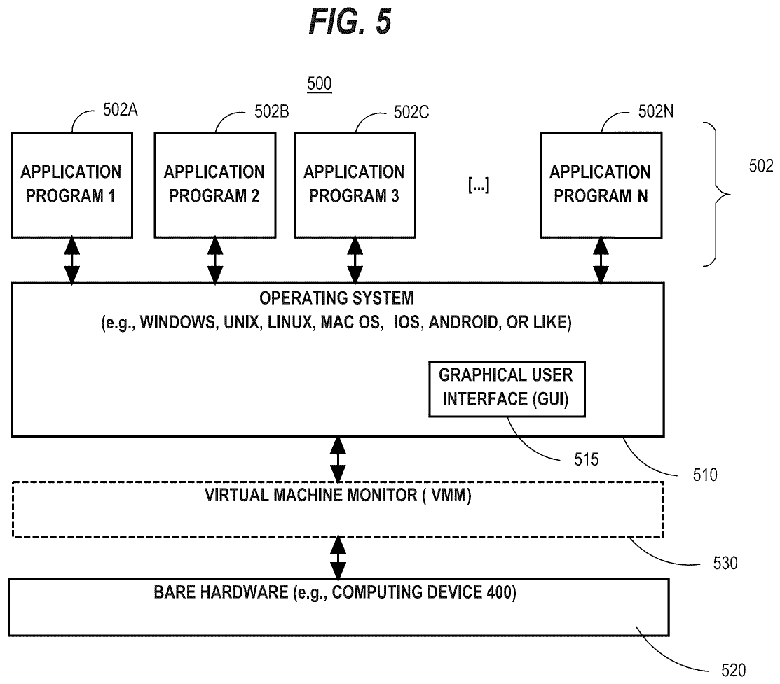

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
for each image in a set of images, storing a set of parameter values for a set of parameters of a first function that describes an object in said each image;
training a neural network based on the set of images and the set of parameter values of each image;
after training the neural network, inputting an image into the neural network;
based on inputting the image into the neural network, generating an output that comprises a set of output parameter values of a particular object depicted in the image;
wherein the method is performed by one or more computing devices.

2. The method of claim 1, wherein the object is a track boundary.

3. The method of claim 2, wherein the track boundary is a first track boundary, the method further comprising:
storing, for each image in the set of images, a second set of parameter values for a second set of parameters of a second function that describes a second track boundary in said each image;
wherein training the neural network is also based on the second set of parameter values of each image.

4. The method of claim 1, wherein the first function is for a first dimension in a multi-dimensional space, the method further comprising:
for each image in the set of images, storing a second set of parameter values for a second set of parameters of a second function that describes the object in said each image;
wherein the second function is for a second dimension, in the multi-dimensional space, that is different than the first dimension.

5. The method of claim 4, wherein the first function is a first polynomial function and the second function is a second polynomial function.

6. The method of claim 1, further comprising:
based on the set of parameter values, determining a lateral position of a moving object that is associated with the image.

7. The method of claim 6, wherein determining the lateral position of the moving object comprises:
determining a position of the particular object based on the set of output parameter values;
generating a difference between a current position of the moving object and the position of the particular object.

8. The method of claim 1, wherein training the neural network comprises minimizing a cost function that is based on a distance between a predicted position of the object in said each image and an actual position of the object in said image.

9. The method of claim 1, wherein the neural network comprises an embedding layer, a set of convolution layers, and a set of fully connected layers.

10. The method of claim 1, further comprising, prior to training the neural network:
for each image in the set of images:
generating a set of points that describe the object in said each image,
generating the set of parameter values of the first function by applying a parametric fitting to the set of points.

11. The method of claim 10, further comprising:
defining a size of a bounding box;
for each image in the set of images:
projecting the bounding box onto a moving object that is associated with said each image;
wherein generating the set of points is based on a coordinate space that is defined by the bounding box.

12. One or more non-transitory storage media storing instructions which, when executed by one or more computing devices, cause:
for each image in a set of images, storing a set of parameter values for a set of parameters of a first function that describes an object in said each image;
training a neural network based on the set of images and the set of parameter values of each image;
after training the neural network, inputting an image into the neural network;
based on inputting the image into the neural network, generating an output that comprises a set of output parameter values of a particular object depicted in the image.

13. The one or more storage media of claim 12, wherein the object is a first track boundary, wherein the instructions, when executed by the one or more computing devices, further cause:
storing, for each image in the set of images, a second set of parameter values for a second set of parameters of a second function that describes a second track boundary in said each image;
wherein training the neural network is also based on the second set of parameter values of each image.

14. The one or more storage media of claim 12, wherein the first function is for a first dimension in a multi-dimensional space, wherein the instructions, when executed by the one or more computing devices, further cause:
for each image in the set of images, storing a second set of parameter values for a second set of parameters of a second function that describes the object in said each image;
wherein the second function is for a second dimension, in the multi-dimensional space, that is different than the first dimension.

15. The one or more storage media of claim 12, wherein the instructions, when executed by the one or more computing devices, further cause:
based on the set of parameter values, determining a lateral position of a moving object that is associated with the image.

16. The one or more storage media of claim 15, wherein determining the lateral position of the moving object comprises:
determining a position of the particular object based on the set of output parameter values;
generating a difference between a current position of the moving object and the position of the particular object.

17. The one or more storage media of claim 12, wherein training the neural network comprises minimizing a cost function that is based on a distance between a predicted position of the object in said each image and an actual position of the object in said image.

18. The one or more storage media of claim 12, wherein the neural network comprises an embedding layer, a set of convolution layers, and a set of fully connected layers.

19. The one or more storage media of claim 12, wherein the instructions, when executed by the one or more computing devices, further cause, prior to training the neural network:
for each image in the set of images:
generating a set of points that describe the object in said each image,
generating the set of parameter values of the first function by applying a parametric fitting to the set of points.

20. The one or more storage media of claim 19, wherein the instructions, when executed by the one or more computing devices, further cause:
defining a size of a bounding box;
for each image in the set of images:
projecting the bounding box onto a moving object that is associated with said each image;
wherein generating the set of points is based on a coordinate space that is defined by the bounding box.
